(19) United States
(12) Patent Application Publication
(10) Pub. No.: US 2003/0209368 A1
(43) Pub. Date: Nov. 13, 2003

(54) Method and apparatus for protecting and servicing a food weighing apparatus

(75) Inventor: James Asbury, Simpsonville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hayssen

(21) Appl. No.: 10/144,647

(22) Filed: May 13, 2002

(51) Int. Cl. G01G 21/10

(52) U.S. Cl. 177/184

(57) ABSTRACT

The present invention discloses methods and apparatus to protect a loadcell that is incorporated into a scale or weighing device (including a combinational weigher) during shipment, handling, movement, maintenance or cleaning of the device. The invention protects the loadcell by inserting one or more rods or braces into one or more holes in the beam of the loadcell or by mechanically pinning, grasping, bracing, screwing, or holding the loadcell or the actuator, thus protecting the beam and preventing bending. The invention may protect (and release) the loadcell either automatically or manually.

### FIELD OF THE INVENTION

The present invention relates to weighing devices including combinational weighers such as those used in weighing food or other items. In particular, the present invention relates to methods and apparatus for “securing” a loadcell in a weighing scale head of a combinational weigher in order to prevent damage to the loadcell to allow the weighing scale to be removed from service, handled, maintained or cleaned. Various uses of a plurality of scales in combination and in various operating modes are also contemplated.

### BACKGROUND OF THE INVENTION

Many modern scales, including but not limited to those used in combinational weighers, utilize a strain gauge transducer, commonly called a “loadcell” for weight measurement. The strain gauge transducer is typically partially comprised of a rectangular metal beam that is milled with one or more “T” or “dog-bone” shaped voids in its center and with a number of strain gauges located on the periphery of the beam where the metal beam has been milled to its thinnest thickness. The weight of a substance to be weighed is transferred to the beam resulting in deflection of the beam at the locations where the strain gauges are located. The strain gauges are electrically connected in a bridge manner, typically a wheatstone-type circuit. This deflection causes a change of electrical resistance across the electrical bridge network incorporating the strain gauges. This change in resistance can be utilized to create a change in an electrical signal and thus the weight transferred to the beam can be detected and measured.

Typical scales and weighing devices have a deadweight that is applied to the beam at all times as part of the mechanism to transfer the weight of the substance to be weighed to the beam. A scale is calibrated such that the weight of the deadweight alone on the beam is not included when weighing a substance. Loadcells have a physical capacity weight limit, above which the loadcell will be damaged. The deadweight may be as large as 50-75% of loadcell capacity and is attached to the beam through an actuator or may comprise a part of the actuator. The actuator may be connected to a bucket or platform that holds the substance to be weighed.

When a scale is removed from service and, for example, is moved from one location to another (e.g. mailed back to the manufacturer for repair), sudden movement of this deadweight and the forces exhibited thereby can cause irreversible damage to the strain gauge transducer, such as by permanently bending the beam. Loadcells may also be damaged through high-pressure washing of the weighing device's bucket or platform where the high-pressure spray may exert a force upon the weighing device's bucket or platform that exceeds the capacity of the loadcell. A new loadcell to replace a damaged one may cost between approximately $500-$1,000 each.

U.S. Pat. No. 4,515,232 (“Rubinstein”) discloses a method of protecting loadcells through the use of safety screws inserted through the loadcell. Rubinstein, however, is for use only during the process of manufacturing the loadcell and its initial shipment to a consumer. The safety screws are left in place until the units are incorporated into scales and the scales are installed for their ultimate use. Under Rubinstein, it appears to applicant that the scale or weighing device would have to be disassembled and the screws re-installed in order to prevent damage to the loadcell during movement or handling of the scale or weighing device incorporating the loadcell. It may be difficult to re-install the safety screws in the field or they may have been lost or discarded since the scale was installed.

Therefore, an unsatisfied need exists for methods and apparatus to safely secure a loadcell that overcomes deficiencies in the prior art, some of which are discussed above.

### SUMMARY OF THE INVENTION

Generally described, the present invention secures a loadcell within a weighing device, such as but not limited to combinational weighers, to reduce the opportunity for damage thereto.

Specifically, the loadcell is either automatically or manually or secured when the scale is removed from service, cleaned, or maintained so as to prevent damage to the loadcell caused by movement or handling.

One aspect of the present invention is to provide a method to protect a loadcell from damage caused by excessive forces exerted upon the loadcell comprising inserting one or more rods or braces into a (milled-out, e.g.) void portion of a beam of the loadcell.

Another aspect of the present invention is to provide a method to protect a loadcell from damage caused by excessive forces exerted upon the loadcell comprising inserting one or more rods or braces into one or more holes in a beam of the loadcell, the holes adapted to receive the rods or braces.

Yet another aspect of the present invention is to provide a method to protect a loadcell from damage caused by excessive forces exerted upon the loadcell comprising inserting one or more rods or braces into the milled-out void portion of a beam of the loadcell, and inserting one or more rods or braces into one or more holes in the beam of the loadcell, the holes adapted to receive the rods or braces.

Another aspect of the present invention is a scale or weighing device having a loadcell, the loadcell comprising a beam with one or more milled-out void sections and one or more strain gauges; and, means for securing the loadcell to protect it from damage caused by excessive forces exerted upon the loadcell.

Another aspect of the present invention is a scale or weighing device having a loadcell, the loadcell comprising a beam with one or more milled-out void sections and one or more holes in said beam and one or more strain gauges; and, means for securing the loadcell to protect it from damage caused by excessive forces exerted upon the loadcell 10.

Other aspects of the invention include the control of various loadcells within weighing devices used within combinational weighing apparatuses.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an exemplary loadcell 10, in an embodiment of the invention.

FIG. 2 illustrates a side view of a beam of an exemplary loadcell with one milled-out void area 14 in an embodiment of the invention.

FIG. 3 illustrates a top view of a beam 12 of an exemplary loadcell with one milled-out void area defined at least in part by the two dotted lines.

FIG. 4 illustrates a flexure portion 18, where the beam of an exemplary loadcell is milled to a relatively thin thickness.

FIG. 5 illustrates a side view of the milled beam 12 of an exemplary loadcell with holes 26 (four shown) created for the insertion of rods or braces to secure the loadcell and discourage permanent deformation of the beam of a loadcell.

FIG. 6 illustrates a top view of a pair of actuator mechanisms inserting the rods or braces into the beam 12 of an exemplary loadcell.

FIG. 7 illustrates an end view of an actuator mechanism configured to insert the rods or braces into the beam 12 of an exemplary loadcell.

FIG. 8 illustrates an exemplary scale or weighing device 80 that includes a loadcell 10 and a securing mechanism 82 to secure the loadcell. A bucket hanger 101 is shown for supporting a weighing bucket 100. The weighing bucket 100 is configured to accept, weigh, and release material 105 such as food or nonfood items, which are typically but not necessarily dry. This material could be food, or could be non-food tiems such as hardware nuts and bolts, plastic PVC pieces, wooden craft pieces, etc. It should be understood that this weighing device could be one of a plurality of similar weighing devices used together in a combinational weighing device (combinatinal weighing devices are presumed as known in the art).

FIG. 9A illustrates an exemplary scale or weighing device 90 that has a loadcell and is installed in base 92 of a mechanism employing the scale or weighing device 90. This figure shows the device in its installed position.

FIG. 9B illustrates the exemplary scale or weighing device 90 after it is removed a distance “D” from the base of a mechanism employing the scale or weighing device. During this removal step, a spring mechanism secures the loadcell.

FIG. 10 is a flowchart illustrating an exemplary method of automatically securing a loadcell when supply power is disconnected from the scale or weighing device that incorporates the loadcell, in an embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one skilled in the art, the present invention may be embodied as an apparatus, a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implemented computer software. Any suitable computer-readable storage medium may be utilized including hard disks, CD-ROMs, optical storage devices, or magnetic storage devices.

One aspect of the present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present invention provides devices and methods to secure a loadcell, as such a device is incorporated into a weighing device or scale, to prevent irreversible deformation of the beam of the loadcell as such damage may be caused by excessive force applied to the loadcell by, for example, movement of the weighing device or scale that utilizes the loadcell or high-pressure washing of the bucket or platform of the weighing device or scale that utilizes the loadcell.

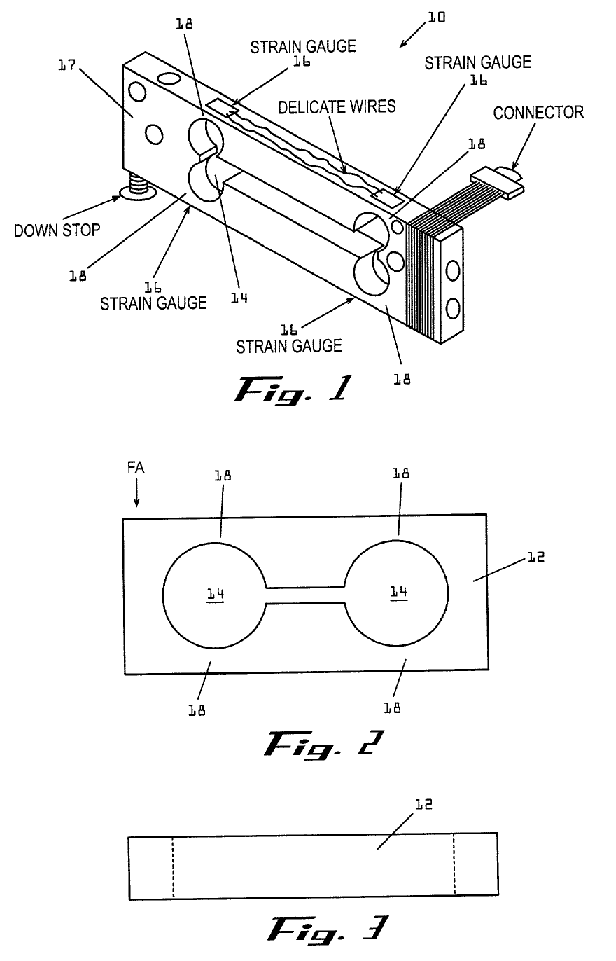

Referring now to FIG. 1, loadcells 10 are devices used within scales and weighing devices to convert the weight applied to the scale and transferred to the loadcell 10 into an electrical signal. Loadcells 10 are typically comprised of a rectangular metal beam 12 that is milled with one or more “T” or dog-bone shaped voids 14 in its center. A number of strain gauges 16 are typically located on the periphery of the beam 12 where the metal beam 12 has been milled to its thinnest thickness, although there are numerous variations of this basic loadcell design. The areas where the beam 12 is milled to its thinnest thickness are called “flexures” 18.

Strain gauges 16 are well known in the art and serve to convert mechanical force (“strain”) into an electrical signal by varying the electrical resistance of the device proportionate to the amount of mechanical tension or compression applied to the device. Strain gauges 16 cannot physically withstand the force that would be applied to them if they were directly used to measure weight in a scale; therefore, they are used in conjunction with the milled beam 12 so that the forces applied to the milled beam 12 deflect the beam 12 at its flexures 18 and the strain gauges 16 detect this deflection and vary their electrical resistance accordingly.

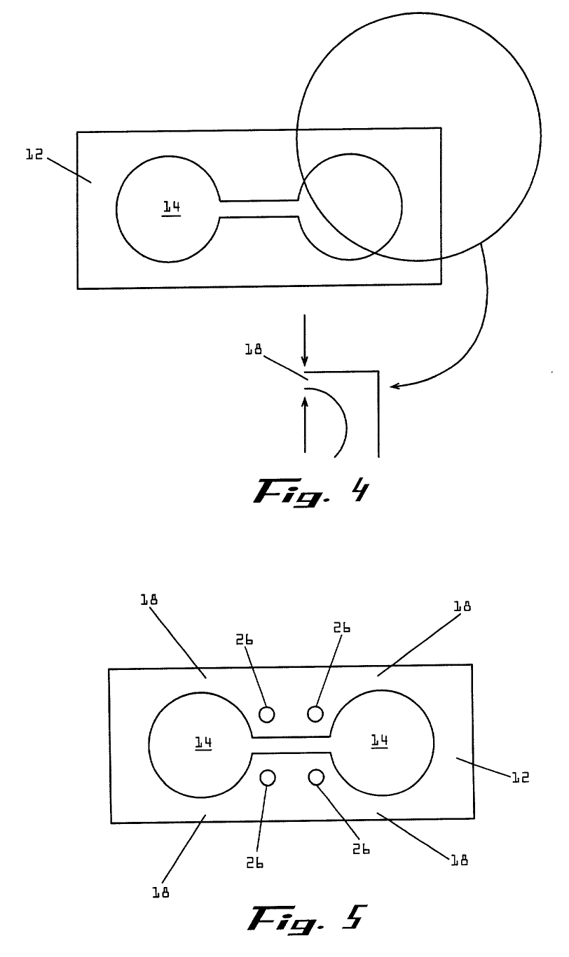

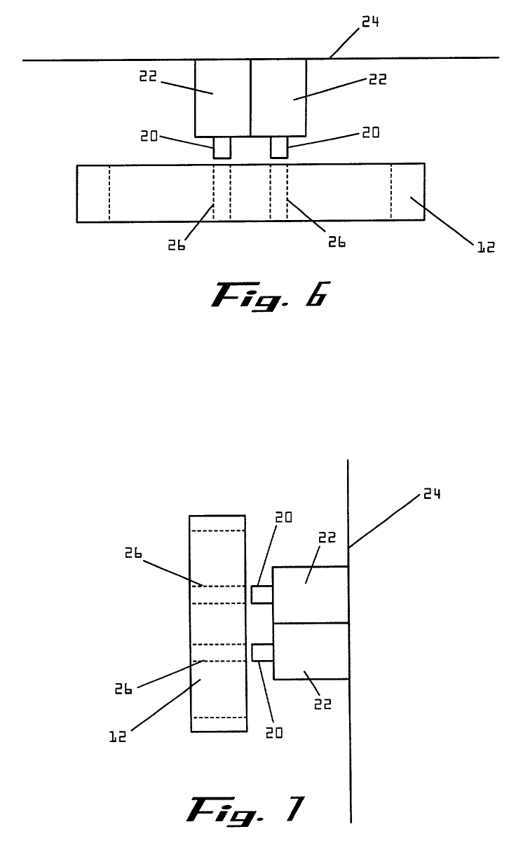

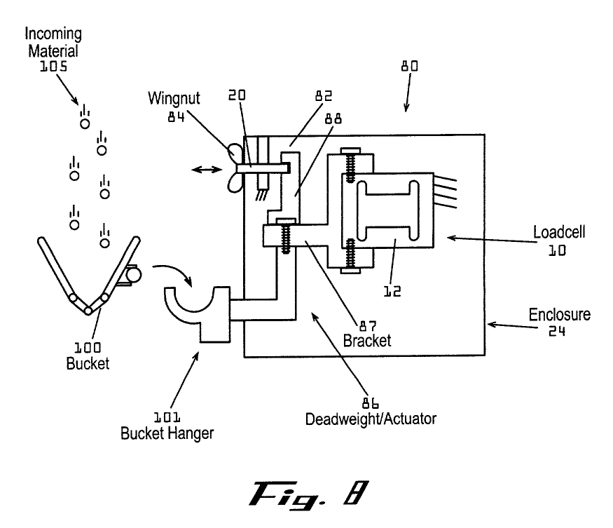

Referring now also to FIGS. 2, 3, and 4, the flexure areas 18 of the beam 12 of a loadcell 10 are milled very thin (often only one to two millimeters thick) to allow deflection at the flexures 18 when a weight is applied to the loadcell 10 such as along force arrow “FA” in FIG. 2 (assuming the opposite end is relatively fixed). The strain gauges 16 are attached to the loadcell 10 over the flexures 18 so they can respond to minute deflection of the beam 12. If a force of a sufficient amount is applied to the loadcell 10, permanent deformation of the flexures 18 may occur. Because weight may be a component of force, a loadcell 10 has a physical weight capacity limit. If a weight that exceeds the loadcell's capacity is applied to the loadcell 10, the loadcell 10 may be permanently damaged and require repair or replacement.

In many cases, a large deadweight (sometimes 50-75% of loadcell capacity) is attached to the beam 12 through an actuator or may comprise part of the actuator. When the scale is handled or shipped, the deadweight may cause the actuator to move and the resulting force may damage the loadcell 10, such as by the flexures 18 on the loadcell beam 12 bending. If too much force or weight is imparted upon the loadcell beam 12, the flexures 18 will permanently deform, thus destroying the loadcell 10.

The invention under consideration secures the loadcell 10 to allow it to be moved. Specifically, the loadcell 10 is either automatically or manually secured when the scale is removed from service so as to prevent damage to the loadcell 10 caused by movement or handling.

Proposed embodiments of the invention may mechanically do one or more of the following: pin, grasp, brace, screw, or hold the loadcell or the actuator to secure the loadcell and prevent its incurring damage caused by excessive force or weight applied to the loadcell 10. The embodiments may, for example, include the use of solenoids 22 that automatically secure the loadcell 10 if (a) supply power is removed from the scale or weighing device for a certain period of time, (b) the mounting hardware holding the scale in place is loosened or removed, or (c) the solenoid 22 is manually actuated. The secure feature in the above embodiments would automatically release once power is reconnected to the scale (FIG. 10), when the mounting hardware is reinstalled, or when manually retracted, respectively. Alternative embodiments of the invention include systems and methods to manually secure the loadcell 10 such as, for example, through mechanical embodiments utilizing handles, wing-nuts, or springs.

Reference is now made to FIGS. 5-7. Generally, in an embodiment of the present invention, the loadcell 10 is protected by inserting one or more mechanical rods or braces 20 into the milled beam 12 of the loadcell 10 such that the rods or braces 20 serve to protect the beam 12 by preventing excessive bending of the beam 12 at the flexures 18 that could permanently damage the beam 12.

One end of each of the rods or braces 20 is mechanically affixed through an actuating mechanism 22 to the structure of the enclosure 24 housing the beam 12. The point of attachment may be to any side, bottom or top of the enclosure 24 and said attachment may employ some form of bracket to facilitate affixing the rod, brace 20 or actuating mechanism 22 to the enclosure 24. The purpose of the rods or braces 20 is to provide additional support to the beam 12 to prevent deformation; therefore the rods, braces 20 or actuating mechanism 22 may be affixed anywhere within the enclosure 24 containing the beam 12 to provide said additional support.

The other end of each of the rods or braces 20 is configured to be inserted into one or more holes 26 that have been created in the beam 12. Said holes 26 are placed in the beam 12 as necessary to receive the rods or braces 20 and to support the beam 12 and help prevent excessive bending of the beam flexures 18 that may result in permanent deformation. Alternatively, the rods or braces 20 may insert into the milled out portion 14 of the beam 12 such that the rods or braces 20 will help prevent excessive bending of the beam flexures 18 that may result in permanent deformation.

The rods or braces 20 may be of any geometric shape, for example, cylindrical, rectangular, square, triangular, oval, tapered, or any combination thereof, and may be threaded. The holes 26 in the beam 12 to receive the rods or braces 20 shall be shaped to receive the rods or braces 20 employed, and if the rods or braces 20 is threaded, the hole 26 to receive the threaded rods or braces 20 shall be threaded to receive same. The rods or braces 20 may be made of any material or any combination of materials so as to provide support to the beam 12.

One embodiment of the invention utilizes solenoid type devices 22 to electronically actuate one or more mechanical rods or braces 20 that secures the loadcell 10. In one aspect, the solenoid 22 automatically actuates after the main power circuit is shut off to the scale or weighing device that employs the loadcell 10. The solenoid 22 may actuate after a delay from the time the power is discontinued so as to avoid unwanted securing caused by momentary interruptions in the power supply. Said solenoid 22 may automatically actuate and release the loadcell 10 once the power supply has been restored to the weighing device. This release action may also occur after a time delay which begins when the power supply is restored in order to avoid premature release of the loadcell 10. In another aspect, a person manually activates the solenoid 22 by a button, switch, lever or any other mechanism to secure the loadcell 10 before commencing any repair and/or maintenance of the weighing device. The manual activation means may also be used to release the rods or braces 20 once the weighing device has been reinstalled in its proper location.

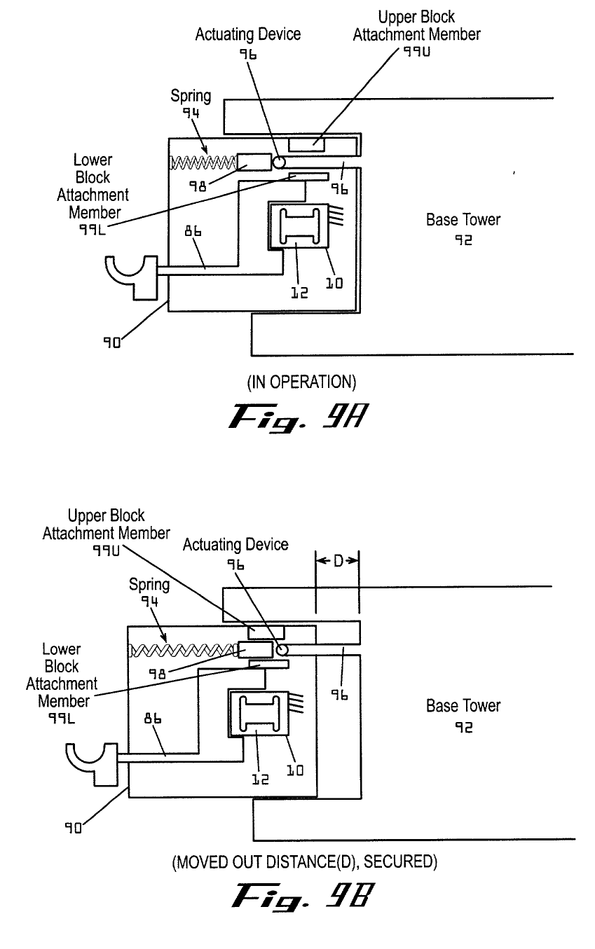

Other embodiments of the invention involve non-electronic methods to secure the loadcell 10. FIG. 8 illustrates an exemplary scale or weighing device 80 configured for supporting a bucket 100 by use of a bucket hanger 101. The bucket hanger 101 is itself supported by a deadweight/actuator 86 which is attached to the free end of a loadcell 10 by use of a bracket 87. Therefore, the loadcell 10 can be used to weigh food or other suitable items such as 105 placed in the bucket 100 such as is needed in the food packaging industry. This material can come from an incoming conveying path such as known in the art.

However, there may be a need to protect the loadcell from damage when the device is being serviced, cleaned, etc., when the bucket 100 is in place, has been removed, or while the bucket is being installed or removed. This protection is provided by use of a securing mechanism 82, which is the embodiment shown includes a wing-type (e.g., a “wingnut”) grasping portion 84. By manually activating the securing mechanism 82, an extension 88 of the deadweight actuator 86 is secured relative to the frame of the device 80, thus protecting (“securing”) the loadcell 10.

In this embodiment, the mechanism 82 is used in association with the enclosure 24 housing the loadcell 10. The mechanism 82 includes an external graspable portion 84 or other actuating means that is used to secure the loadcell 10, and can be a wingnut or other type. The external handle 84 may be rotated, pushed, or activated in some other manner to actuate the internal mechanism 82, thus resulting in one or more rods or braces 20 securing the loadcell beam 12 by, for example, inserting one or more of the rods or braces 20 into the loadcell beam 12, actuator 86, an extension 88 to the actuator 86 (as illustrated in FIG. 8), or any other location that will prevent excessive forces from being applied to the loadcell beam 12, prior to handling, shipping, maintenance or cleaning. The external handle mechanism 84 is also used to release the rods and braces 20 from the loadcell 10 thus freeing it.

The external handle mechanism 84 and associated rod or brace 20 may be mechanically locked or held in place when the loadcell 10 is secured or unsecured. Locking when secured is advantageous during movement so it is unlikely to loosen thus releasing the rod(s) or brace(s) 20 and possibly damaging the loadcell 10. Locking when unsecured is advantageous so the loadcell 10 will not be inadvertently secured during operation of the weighing mechanism.

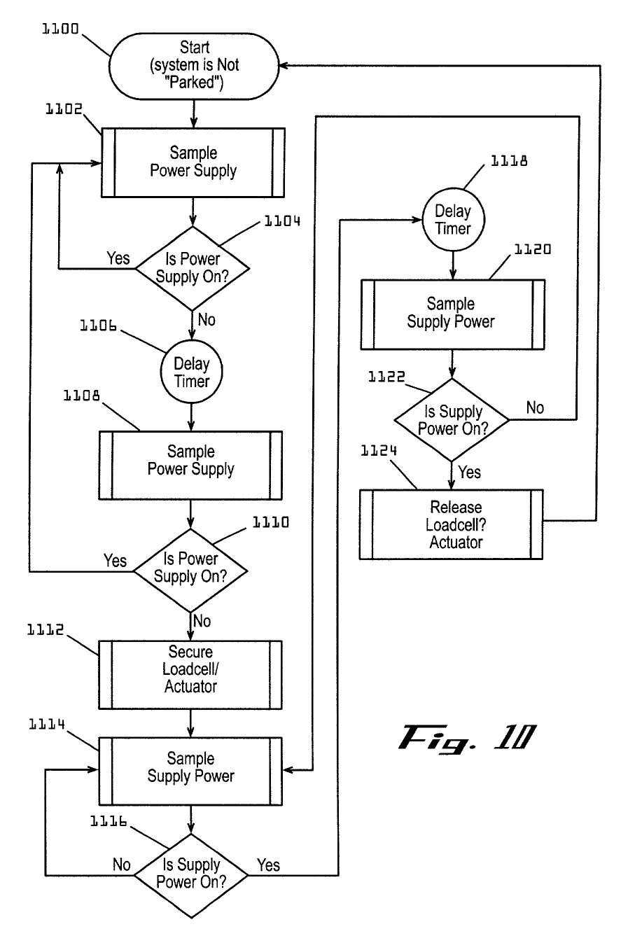

FIGS. 9A and 9B are related views showing the operation of a weighing device 90 including a loadcell 10 therein. Generally described, this apparatus 90 is configured to be selectively detached from a base tower 92, such that when the device 90 is removed from the base tower 92 from the position of FIG. 9A to that of FIG. 9B, the loadcell 10 is automatically secured by use of a spring 94, a block 98, a pair of block attachment members 99U, 99L, and an actuating device 96.

FIG. 9A illustrates the weighing device 90 with a loadcell 10 which is installed in base 92 of a mechanism employing the scale or weighing device 90. In this configuration the weighing device is in its operating position, with the loadcell 10 being unsecured. As described below, a spring mechanism 94 assists in securing the loadcell 10 upon removal of the scale or weighing devise 90 from the base 92 from this position to the position of FIG. 9B. In the FIG. 9A mode, the actuating device 96 is of such dimensions that it does not prevent the loadcell 10 from moving as needed to detect and measure the weight of substances, thus allowing the loadcell 10 a full range of motion. However, the actuating device maintains the block 98 out of contact or other engagement with the upper and lower block engagement members 99U, 99L, described later.

Referring now to FIG. 9B, when the weighing device 90 is removed from the base 92 at least a distance “D”, the actuating device 96 eventually moves out of contact with the block 98, thus allowing the spring system 94 to urge the block 98 into contact with the upper and lower block attachment members 99U, 99L. This contact which could be frictional, mechanical, magnetic, or otherwise, is configured in a suitable location so as to substantially prevent the transfer of weight and force to the loadcell 10, thus securing the loadcell 10 for movement, maintenance, or cleaning. The block 98 may be movably mounted relative to the remainder of the mechanism by various means. It can be slidably mounted on a linear path by suitable means, it may pivot or rotate into place, or other relative movement may be used.

FIG. 10 is a flowchart illustrating an exemplary method of automatically securing a loadcell when supply power is disconnected from the scale or weighing device that incorporates the loadcell, in an embodiment of the invention. A mechanism, such as, for example, one or more of a controller, a computer, a processor, or a logic circuit (standalone or part of a control system) may be used to provide the logic to carry out the operations described in this FIG. 10.

In Step 1100, the loadcell is not secured and is free to move as needed in order to weigh substances. In Steps 1102 and 1104, the power supply to the weighing device or scale is sampled (Step 1102) and, if power is being supplied to the weighing device or scale, no action is taken and the power supply is monitored. If, in Step 1104, the power supply has been discontinued, a delay timer is activated (Step 1106). Once the delay timer has timed out, in Step 1108 the power supply is once again sampled. If the power supply has resumed during the delay period (Step 1110), the system begins to monitor supply power (Step 1102) once again. If, in Step 1110, the power supply has not returned during the delay period, the beam and/or actuator of the loadcell is secured by one or more of pinning, grasping, bracing, screwing, or holding the loadcell or the actuator to secure the loadcell and prevent its incurring damage caused by excessive force or weight applied to the loadcell in Step 1112.

The purpose of the delay timer (Step 1106) is to prevent unwanted securing of the loadcell that may be caused by inadvertent outages, fluctuations or aberrations in the power supply. The delay time of the delay timer may be adjustable so as to not cause unwanted securing and so that the delay time will not be excessive.

In Steps 1114 and 1116, supply power is once again sampled to determine if the power supply has been reconnected or re-energized. If not, then the system returns to Step 1114 and the supply power is sampled again. If the supply power has returned, then in Step 1118, another delay timer is activated. The delay timer's purpose is to prevent inadvertent “release” of the secured loadcell when the power supply is re-energized for a short time period. Once the time delay has expired, supply power is once again sampled (Step 1120). In Step 1122, if the supply power is once again “off” after the delay interval, then the system returns to Step 1114 to monitor supply power. If the supply power is “on” after the delay interval, then (Step 1124) the loadcell is released by removing one or more of the devices pinning, grasping, bracing, screwing, or holding the loadcell or the actuator. The system then returns to the start (Step 1100) to resume monitoring the power supply.

Additional Options and Alternatives

Under the present invention, it may be desired to use a plurality of scale heads in a combinational weigher, and to treat each scale head individually. Thus, while the overall scale apparatus is running or at least powered up, under the invention there may be a need to only remove head #3. In a manual type mode, the invention contemplates use of a ‘lock’ or ‘unlock’ toggle button either via manual switch or on the touchscreen associated with each head.

The automatic selection of all loadcells for locking/unlocking is under one use of the primary mode of operation. A manual mode is also contemplated. Often, combinational weighers operate without the benefit of all working loadcells. A 14-head scale can run with 13 or even 12 heads (and 12 loadcells) and still maintain decent throughput performance and giveaway accuracy. (The concept is that one obtains more potential combinations with more heads, thus having increased probability of finding an exact match to the target weight). If one head/loadcell is found ‘bad’, the operator never really wants to shut down the entire machine, but if possible would rather operate on the remaining weighing heads. Instead, under the present invention the operator can stop operation (by putting the overall combinational weighing apparatus in a “powered up”, but “idle” mode and investigate the suspect head/loadcell. They would want to manually ‘lock’ that loadcell before removing it from the scale (which continues to be fully powered up, but in an idle mode). The operator can continue to run the scale less one head while the maintenance department repairs the suspect head. When the head is fixed, all the operator has to do is stop the scale (go to idle mode, not power down), install the head/loadcell, ‘un-lock’ it and re-start auto mode. With the manual mode option, the user has flexibility in controlling the power up condition of the combinational weigher.

### CONCLUSION

Therefore, devices and methods are disclosed to secure a loadcell to prevent its damage during moving, handling, transporting, maintaining, or cleaning a weighing device or scale that incorporates a loadcell that either automatically occur or can be conveniently caused to occur manually.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

1. An apparatus for weighing material supplied from a conveying source, said apparatus comprising:
a frame;
a material accepting and releasing device configured to accept a portion of said material;
a loadcell positioned intermediate said frame and said material accepting and releasing device, said loadcell configured to transfer at least a part of said weight of said material accepting and releasing device to said frame and to provide an output signal relating to said part of said weight; and
a securing device for securing a portion said loadcell relative to said frame when not in operation, such securing device when activating causing said part of said weight of said material accepting device not to be transferred through said loadcell.

2. The apparatus as claimed in claim 1, wherein said material accepting and releasing device is a bucket.

3. The apparatus of claim 2, wherein said bucket is configured to accept said material items from above generally said bucket and to selectively discharge said material items generally below said bucket.

4. An apparatus for weighing material items coming from a conveying source, said apparatus comprising:
a frame;
a subframe configured for attachment relative to said frame at a first, docked, position relative to said frame, but also configured to be detached relative to said frame by movement to a second, undocked, position relative to said frame;
a material accepting and releasing device configured to accept a portion of said material;
a loadcell intermediate said material accepting and releasing device and said subframe, said loadcell configured to transfer at least a part of said weight of said material accepting and releasing device to said subframe and to provide an output signal relating to said part of said weight;
a securing device for securing a portion of said loadcell relative to said subframe when said subframe is in said second position, said securing causing said part of said weight of said material accepting device not to be transferred through said loadcell; and
such that upon movement of said subframe from said first to said second position, said deflection said loadcell is automatically restricted so as to discourage said deflection movement.

5. The apparatus as claimed in claim 4, wherein said securing device includes a securing block which provides a connection between said subframe and said loadcell when said subframe is in said second position.

6. An apparatus for weighing material coming from a material conveying source, said apparatus comprising:
A) a plurality of weighing subapparatuses, each of said subapparatuses comprising:
1) a subframe;
2) a material accepting and releasing device;
3) a loadcell intermediate said material accepting and releasing device and said subframe, said loadcell configured to transfer at least a part of said weight of said material accepting and releasing device to said subframe and to provide an output signal relating to said part of said weight; and
4) a securing device for securing a portion of said loadcell relative to said subframe when said subframe is in said second position, said securing causing said part of said weight of said material accepting device not to be transferred through said loadcell;
B) a control that allows for independent control of each of said plurality of securing devices, said independent control including independent control of said securing devices of each of said plurality of weighing subapparatuses, said control configured to allow an operator to disable one of said weighing subapparatuses while allowing operation of the other remaining weighing subapparatuses of said plurality of weighing subapparatuses, said disabling including the activation of said securing device of said one of said weighing subapparatuses by use of said control.

7. A method of weighing material coming from a material conveying source, said method comprising the steps of:
A) providing a plurality of weighing subapparatuses, each of said subapparatuses comprising:
1) a subframe;
2) a material accepting and releasing device;
3) a loadcell intermediate said material accepting and releasing device and said subframe, said loadcell configured to transfer at least a part of said weight of said material accepting and releasing device to said subframe and to provide an output signal relating to said part of said weight; and
4) a securing device for securing a portion of said loadcell relative to said subframe when said subframe is in said second position, said securing causing said part of said weight of said material accepting device not to be transferred through said loadcell;
B) providing a control that allows for independent control of each of said plurality of securing devices, said independent control including independent control of said securing devices of each of said plurality of weighing subapparatuses; and
C) disabling one of said weighing subapparatuses while allowing operation of the other remaining weighing subapparatuses of said plurality of weighing subapparatuses, said disabling including the activation of said securing device of said one of said weighing subapparatuses by use of said control.

8. A method of weighing material coming from a material conveying source, said method comprising the steps of:
A) providing a plurality of weighing subapparatuses, each of said subapparatuses comprising:
1) a subframe;
2) a material accepting and releasing device;
3) a loadcell intermediate said material accepting and releasing device and said subframe, said loadcell configured to transfer at least a part of said weight of said material accepting and releasing device to said subframe and to provide an output signal relating to said part of said weight; and
4) a securing device for securing a portion of said loadcell relative to said subframe when said subframe is in said second position, said securing causing said part of said weight of said material accepting device not to be transferred through said loadcell;
B) providing a control that allows for independent control of each of said plurality of securing devices, said independent control including independent control of said securing devices of each of said plurality of weighing subapparatuses;
C) diagnosing said plurality of weighing subapparatuses to determine a need for repair of any one of said plurality of weighing subapparatuses;
D) selecting one of said plurality of weighing subapparatuses for repair; and
E) disabling one of said weighing subapparatuses while allowing operation of the other remaining weighing subapparatuses of said plurality of weighing subapparatuses, said disabling including the activation of said securing device of said one of said weighing subapparatuses by use of said control.

9. An apparatus for weighing items of material supplied from a conveying source, said apparatus comprising:
a frame;
a material accepting and releasing device configured to accept a portion of said material;
a loadcell positioned intermediate said frame and said material accepting and releasing device, said loadcell configured to transfer at least a part of said weight of said material accepting and releasing device to said frame and to provide a signal relating to said part of said weight;
an electrical power component providing an output signal as to whether power is or is not being provided to said power component; and
a loadcell securing device configured to secure said loadcell relative to said frame upon a determination that power has not been provided to said electrical power component for a predetermined time period.
